(19) United States
(12) Patent Application Publication
(10) Pub. No.: US 2026/0132858 A1
(43) Pub. Date: May 14, 2026

(54) Double-handle faucet body structure and forming mold for the same

(71) Applicant: Guangdong Meijie Faucet Company Limited, Dongguan (CN)

(72) Inventors: Xiaohua Luo, Dongguan (CN); Huaitong Deng, Dongguan (CN); Yuhua Xiong, Dongguan (CN)

(21) Appl. No.: 18/969,409

(22) Filed: Dec. 5, 2024

(30) Foreign Application Priority Data
Nov. 11, 2024 (CN) 202422745927X

(51) Int. Cl. F16K 11/22; B29C 45/26; B29L 31/00

(52) U.S. Cl. CPC F16K 11/22; B29C 45/2602; B29L 2031/7506

(57) ABSTRACT

A double-handle faucet body structure includes a first metal pipe and a second metal pipe, a first valve seat plugged into the first metal pipe, a second valve seat plugged into the second metal pipe, and a housing wrapped and connected to the first valve seat and the second valve seat; the first valve seat has a first valve tube, a first inner tube provided under the first valve tube, and a first threaded tube provided on the first valve tube; the first inner tube is inserted into the first metal tube; the second valve seat has a second valve tube, a second inner tube provided under the second valve tube, and a second threaded tube provided on the second valve tube, the second inner tube is inserted into the second metal tube.

### TECHNICAL FIELD

The present invention relates to the technical field of the faucet, more particularly, to a double-handle faucet body structure and a forming mold for the same.

### BACKGROUND OF THE INVENTION

The double-handle faucet is generally configured with an H shape, which includes a connecting tube and two valve seats arranged at two sides of the connecting tube. A water outlet is provided on the connecting tube. The existing double-handle faucet is generally formed by injection molding, for example, Chinese Patent CN108662204B discloses a matching structure of a double-handle faucet body and a faucet valve core. The double-handle faucet body includes integrally injection-molded left and right side bodies and a central body. Each side body comprises a valve seat and an inlet pipe connected to the bottom of the valve seat. Two sides of the central body are respectively connected to the side bodies. The bottom of the valve seat is in communication with the water inlet channel in the inlet pipe. One side of the valve seat is equipped with a water outlet channel facing the central body and a water outlet communicating with the water outlet channel. The other side of the valve seat is provided with a core-pulling hole directly facing the water outlet. A valve core is fixed in each of the valve seats. An isolation seal is provided between the outer wall of a valve housing of the valve core and the inner wall of the valve seat. The isolation seal blocks the communication between the core-pulling hole and the inlet pipe of the valve seat and blocks the communication between the core-pulling hole and the inlet pipe of the valve seat.

The technical solution in Chinese Patent CN108662204B solves the problem of water leakage caused by the core-pulling hole by providing the isolation seal. In the technical solution, the double-handle faucet body is integrally injection-molded, the requirement for the accuracy of the mold is high, and after the double-handle faucet body is molded, the difficulty of core-pulling is increased, resulting in low production efficiency and a low yield. In addition, the faucet formed according to the above technical solution needs to install the isolation seal, which increases the installation procedures and production costs.

Therefore, there is an urgent need to improve the technical solution to overcome the defects of the prior art.

### SUMMARY OF THE INVENTION

To overcome the defects of the prior art, the present disclosure discloses a double-handle faucet body structure and a forming mold for the same, solving the technical problem that in the prior art after the double-handle faucet body is molded, the difficulty of core-pulling is large and water leakage is easily caused.

The technical solutions of the present disclosure are as follows: a double-handle faucet body structure includes a first metal pipe, a second metal pipe, a first valve seat plugged into the first metal pipe, a second valve seat plugged into the second metal pipe, and a housing wrapped and connected to the first valve seat and the second valve seat.

The first valve seat has a first valve tube, a first inner tube provided under the first valve tube, and a first threaded tube provided above the first valve tube. The first valve tube is configured to accommodate a valve body, the first inner tube is inserted into the first metal tube, and the first threaded tube is used to connect to a handle. A first side tube is provided at a side portion of the first valve tube.

The second valve seat has a second valve tube, a second inner tube provided under the second valve tube, and a second threaded tube provided above the second valve tube. The second valve tube is configured to accommodate the other valve body, the second inner tube is inserted into the second metal tube, and the second threaded tube is used to connect the other handle. A second side tube is provided at a side portion of the second valve tube.

Preferably, the first inner tube is inserted into the first metal tube, the first inner tube is fixedly connected with the first metal tube, and the top end of the first metal tube abuts against the bottom end of the first valve tube to be fixedly connected.

The second inner tube is inserted into the second metal tube, the second inner tube is fixedly connected with the second metal tube, and the top end of the second metal tube abuts against the bottom end of the second valve tube to be fixedly connected.

The first side tube is in communication with the first valve tube, while the second side tube is in communication with the second valve tube. The first side tube and the second side tube are respectively used to transport the water from the first valve tube and the second valve tube to the housing.

The upper portion and the lower portion of the first valve tube are respectively provided with an upper flange and a lower flange along the outer wall thereof for matching with the housing,

The housing includes a connecting tube, the first valve housing, and the second valve housing arranged at both ends of the connecting tube. The first valve housing wraps the first valve tube, the second valve housing wraps the second valve tube. The first valve seat and the second valve seat are arranged side by side so that the first side tube and the second side tube are opposite to each other, and the first side tube and the second side tube are respectively accommodated in the connecting tube. A water outlet is provided in the middle of the connecting tube and is used to connect a water outlet tube.

A plurality of reinforcing ribs is provided at the joints between the connecting tube and the first valve housing and the second valve housing to reinforce the joints.

The forming mold for the double-handle faucet body structure includes a mold base, a stationary mold core disposed on the mold base, and a movable mold core cooperating with the stationary mold core. A first valve seat forming cavity, a second valve seat forming cavity, and a housing forming cavity are provided on the stationary mold core. The first valve seat forming cavity includes an accommodating cavity that receives the first metal tube, a valve seat forming cavity provided at the top of the housing cavity, and a side tube forming cavity. The movable mold core is provided with a first mating cavity that cooperates with the first valve seat forming cavity and a second mating cavity that cooperates with the second valve seat forming cavity. The second valve seat forming cavity has the same structure as the first valve seat forming cavity.

The housing forming cavity includes a connecting tube forming cavity, a first valve seat forming cavity and a second valve seat forming cavity arranged both ends of the connecting tube forming cavity. The movable mold core is provided with a third fitting cavity matched with the housing forming cavity.

The beneficial effects of the present disclosure are as follows: the double-handle faucet body structure in the present disclosure is designed reasonably with a simple structure, easily extracting the mold core, and stably dispersing water without a sealing ring. When the forming mold is first used for injection-molding, only the first valve seat and the second valve seat are formed, and a semi-finished product assembled from the first valve seat and the first metal tube is completed, the other semi-finished product assembled from the second valve seat and the second metal tube is also completed. The mold core is easy to pull, and does not damage the assembled semi-finished products. Then, the semi-finished products are used as the mold core to form the housing outside. The housing formed by means of injection molding only needs to pull a mold core at the water outlet. The process of pulling the mold core is simple, does not damage the double-handle faucet body structure, has a high yield, and avoids the problem of water leakage caused by difficulty in pulling the mold core. Since most portion of the double-handle faucet body structure is molded by injection molding twice, and the wall of the double-handle faucet body structure is thin, the dwell time and the cooling time during injection molding can be shortened, and the production efficiency can be improved. Two-shot injection molding of the double-handle faucet body structure also solves the problem of plastic shrinkage deformation and water leakage caused by the wall thickness thereof too thick, has a high product quality, improves product yield, and reduces the product cost.

### BRIEF DESCRIPTION OF THE DRAWINGS

In order to explain more clearly the technical scheme in the embodiment of the present invention, a brief introduction is given below to the attached drawings needed in the embodiment. Obviously, the attached drawings in the following description are only some embodiments of the present invention, for ordinary technicians in this field, other drawings can be obtained according to these drawings without paying creative labor.

FIG. 1 is a perspective view of the double-handle faucet body structure according to the present disclosure.

FIG. 2 is an exploded view of the double-handle faucet body structure shown in FIG. 1.

FIG. 3 is a sectional view of the double-handle faucet body structure shown in FIG. 1.

FIG. 4 is a perspective view of the valve seat 20.

FIG. 5 is a top view of the valve seat 20 shown in FIG. 5.

FIG. 6 is a front view of an assembled structure of the first valve seat 20 and the first metal tube 10.

FIG. 7 is a top view of FIG. 6.

FIG. 8 is a sectional view along an A-A line in FIG. 7.

FIG. 9 is an exploded view of the forming mold according to the present disclosure.

FIG. 10 is an exploded view of the movable mold core and the stationary mold core of the forming mold according to the present disclosure.

FIG. 11 is an exploded view of another angle of the movable mold core and the stationary mold core shown in FIG. 10.

FIG. 12 is a schematic view of the double-handle faucet body structure manufactured by the forming mold according to the present utility model.

### DETAILED DESCRIPTION OF ILLUSTRATED EMBODIMENTS

The embodiment of the present invention is described in detail below, and an example of the embodiment is shown in the attached Figs., where the same or similar label from beginning to end represents the same or similar element or element with the same or similar function. The following embodiments described by reference to the attached drawings are exemplary and are intended to be used to explain the embodiments of the present invention, and can not be understood as limiting the present invention.

In the description of the embodiment of the present invention, it needs to be understood that the azimuth or position relation indicated in the term “length ”,“ width ”,“ upper ”,“ lower ”,“ front ”,“ rear ”,“ left ”,“ right ”,“ vertical ”,“ horizontal ”,“ top ”,“ bottom ”,“ inside ”,“ outside” and so on is based on the azimuth or position relation shown in the attached figure, only for the convenience of describing the embodiment and simplifying the description of the present invention, rather than indicating or implying that the device or element must have a specific orientation, construction and operation with a specific orientation, so it can not be understood as a restriction on the present invention.

Furthermore, the terms “first ”,“ second” are used only for descriptive purposes and can not be understood as indicating or implying relative importance or implicitly indicating the number of technical features indicated. Thus, the qualification of “first” and “second” features may include one or more of them explicitly or implicitly. In the description of the embodiment of the present invention, the meaning of “multiple” is two or more, unless otherwise specified.

In the embodiments of the invention, unless otherwise clearly specified and defined, the terms, “installed”, “connected”, “or” fixed “should be generally understood, for example, a fixed connection, or a removable connection, a mechanical connection or an electrical connection, or a direct connection or an indirect connection through an intermediate media, or a connection within two elements or the interaction of two elements. For those of ordinary skilled in the art, the specific meaning of the above terms in the embodiment of the present invention may be understood under specific circumstances.

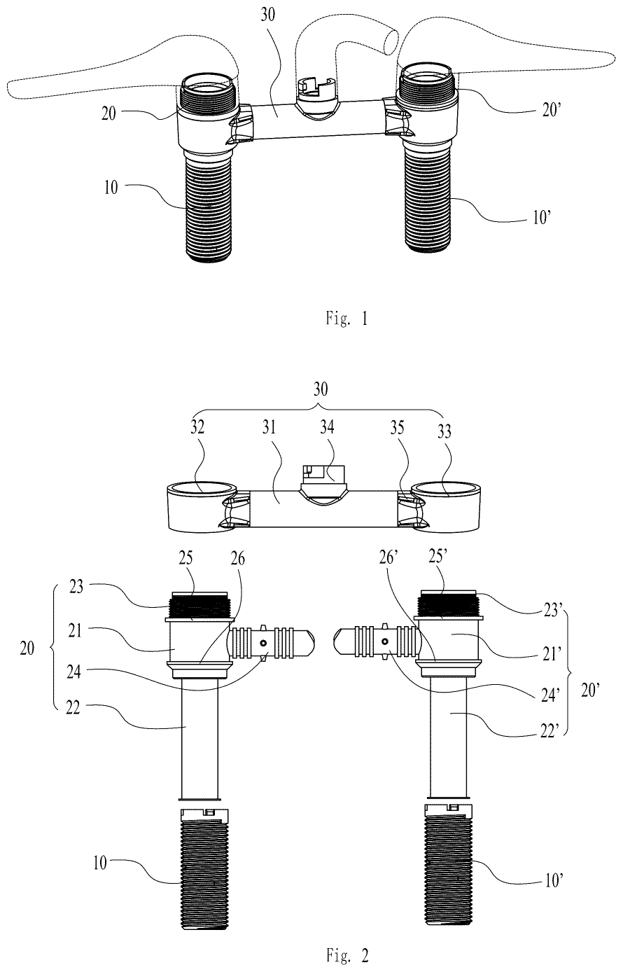

Referring to FIGS. 1-3, a double-handle faucet body structure includes a first metal pipe 10 and a second metal pipe 10′, a first valve seat 20 plugged into the first metal pipe 10, a second valve seat 20′ plugged into the second metal pipe 10′, and a housing 30 wrapped and connected to the first valve seat 20 and the second valve seat 20′.

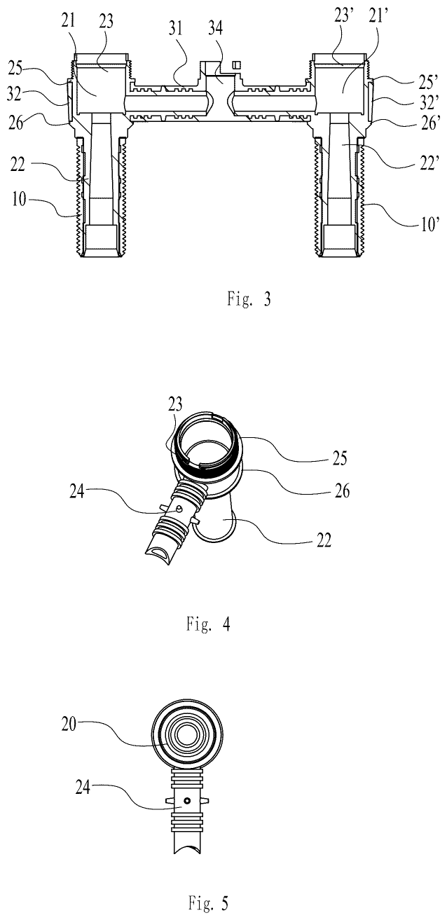

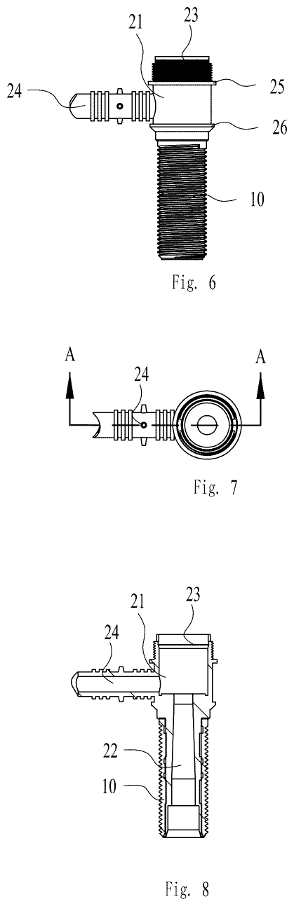

Referring to FIGS. 2-8, the first valve seat 20 has a first valve tube 21, a first inner tube 22 provided under the first valve tube 21, and a first threaded tube 23 provided above the first valve tube 21. The first valve tube 21 is configured to accommodate a valve body (not shown), the first inner tube 22 is inserted into the first metal tube 10, and the first threaded tube 23 is used to connect with a handle. A first side tube 24 is provided at a side portion of the first valve tube 21.

Referring to FIGS. 2-3, the second valve seat 20′ has a second valve tube 21′, a second inner tube 22′ provided under the second valve tube 21′, and a second threaded tube 23′ provided on the second valve tube 21′. The second valve tube 21′ is configured to accommodate a valve body (not shown), the second inner tube 22′ is inserted into the second metal tube 10′, and the second threaded tube 23′ is used to connect with another handle. A second side tube 24′ is provided at a side portion of the second valve tube 21.

Preferably, after the first inner tube 22 is inserted into the first metal tube 10, the first inner tube 22 is fixedly connected with the first metal tube 10, and the top end of the first metal tube 10 abuts against the bottom end of the first valve tube 21 to be fixedly connected.

After the second inner tube 22′ is inserted into the second metal tube 10′, the second inner tube 22′ is fixedly connected with the second metal tube 10′, and the top end of the second metal tube 10′ abuts against the bottom end of the second valve tube 21′ to be fixedly connected.

Referring to FIGS. 1-3, the first side tube 24 is in communication with the first valve tube 21, while the second side tube 24′ is in communication with the second valve tube 21′. The first side tube 24 and the second side tube 24′ are respectively used to transport the water from the first valve tube 21 and the second valve tube 22 to the connecting pipes 31 described below.

The upper portion and the below portion of the first valve tube 21 are respectively provided with an upper flange 25 and a lower flange 26 along the outer wall thereof for matching with the housing 30, The upper portion and the below portion of the first valve tube 22 are respectively provided with an upper flange 25′ and a lower flange 26′ along the outer wall for matching with the housing 30.

Referring to FIGS. 1-2, the housing 30 includes a connecting tube 31, the first valve housing 32 and the second valve housing 33 arranged at both ends of the connecting tube 31. The first valve housing 32 wraps the first valve tube 21, the second valve housing 32 wraps the second valve tube 21′. The first valve seat 20 and the second valve 20′ are arranged side by side so that the first side tube 24 and the second side tube 24′ are opposite to each other, and the first side tube 24 and the second side tube 24′ are respectively accommodated in the connecting tube 31. A water outlet 34 is provided in the middle of the connecting tube 31 and is used to connect a water outlet tube.

A plurality of reinforcing ribs 35 is provided at the joints between the connecting tube 31 and the first valve housing 32 and the second valve housing 33 to reinforce the joints.

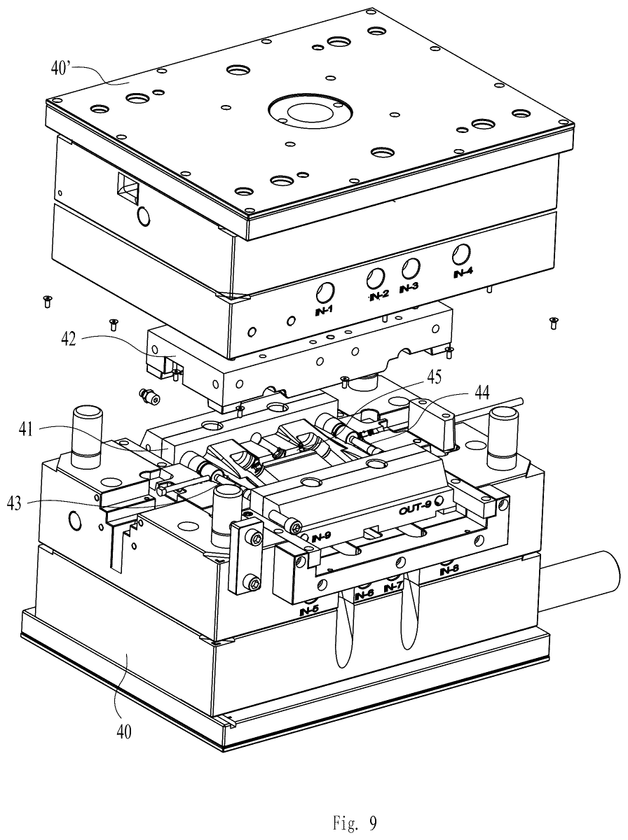

Referring to FIGS. 9-12, the forming mold for the double-handle faucet body structure includes a mold base 40 and 40′, a stationary mold core 41 disposed on the mold base 40, and a movable mold core 42 cooperating with the stationary mold core 41 and disposed on the mold base 40′. A first valve seat forming cavity 43, a second valve seat forming cavity 44□ and a housing forming cavity 45 are provided on the stationary mold core 41. The first valve seat forming cavity 43 includes an accommodating cavity 431 that receives the first metal tube 10, a valve seat forming cavity 432 provided at the top of the housing cavity 431, and a side tube forming cavity 433. The movable mold core 42 is provided with a first mating cavity 46 that cooperates with the first valve seat forming cavity 43 and a second mating cavity 47 that cooperates with the second valve seat forming cavity 44. The second valve seat forming cavity 44 has the same structure as the first valve seat forming cavity 43.

When the first valve seat 20 and the second valve seat 20′ are formed, the first metal cylinder 10, the second metal seat 10′ and the mold core (no shown) are respectively placed in the two accommodating cavities 431, after the movable mold core 42 is assembled with the stationary mold core 41, the first fitting cavity 46 is fitted with the first valve seat forming cavity 43, and the second fitting cavity 47 is fitted with the second valve seat forming cavity 44, liquid plastic is injected into the space between the first valve seat forming cavity 43 and the first fitting cavity 46 and the space between the second valve seat forming cavity 44 and the second fitting cavity 47, forming a first valve seat 20 and a second valve seat 20′, in which the first valve seat 20 is fixedly connected to a first metal tube 10, and the second valve seat 20′ is fixedly connected to a second metal tube 10′. After molding, the mold core can be easily withdrawn without damaging the first valve seat 20 and the first metal tube 10, the second valve seat 20′ and the second metal tube 10′.

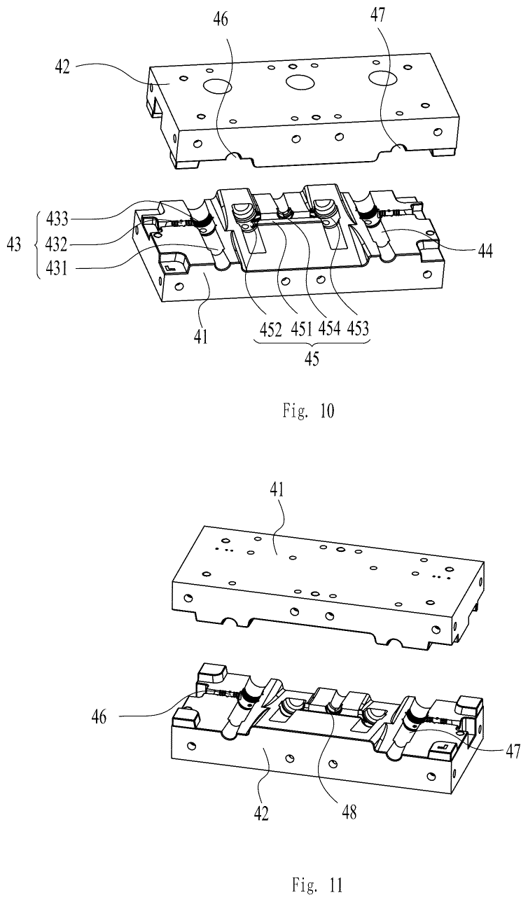

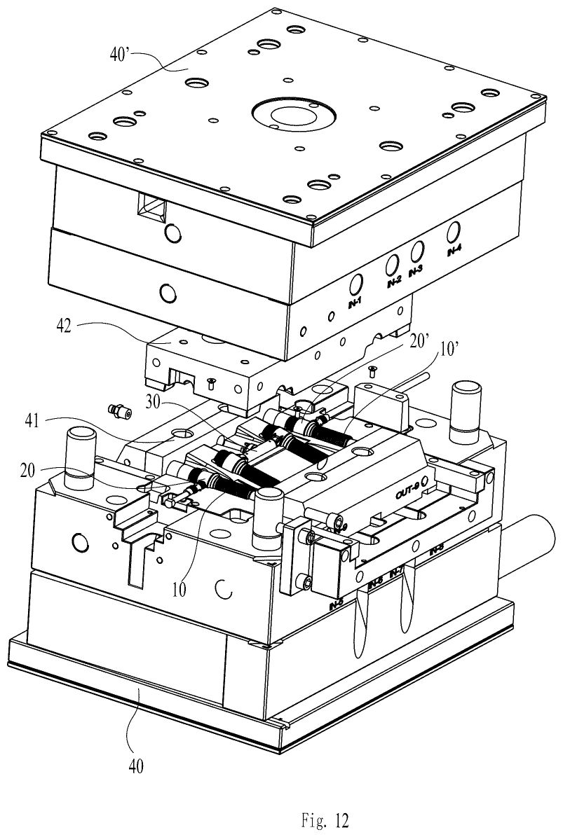

Referring to FIGS. 10 and 12, the housing forming cavity 45 includes a connecting tube forming cavity 451, a first valve seat forming cavity 452, and a second valve seat forming cavity 453 arranged both ends of the connecting tube forming cavity 451, and a water outlet 34 forming cavity 454 at the middle thereof. The movable mold core 42 is provided with a third fitting cavity 48 matching with the housing forming cavity 45. When the housing 30 is formed, the formed first valve seat 20, and the first metal tube 10 are put into the first valve seat forming cavity 452 as a mold core, the formed second valve seat 20′ and the second metal tube 10′ are put into the second valve seat forming cavity 453 as a mold core, only an additional mold core needs to be provided at the water outlet 34. After the movable mold core 42 is assembled with the stationary mold core 41, the third fitting cavity 48 is fitted with the housing forming cavity 45, the liquid plastic material is injected into the space between the housing forming cavity 45 and the third fitting cavity 48 to form the housing 30, the housing 30 wraps and connects the first valve seat 20 and the second valve seat 20′, thereby obtaining the double-handle faucet body structure through twice injection molding processes. After molding, only the mold core at the water outlet needs to be extracted. The process of pulling the mold core is simple, easy to operate, and will not damage the double-handle faucet body structure.

The present disclosure is described in further detail with reference to specific preferred embodiments, and it cannot be determined that the specific implementation of the present disclosure is only limited to these descriptions. For a person of ordinary skill in the art to which the present disclosure belongs, on the premise of not departing from the concept of the present disclosure, the architecture form of the present disclosure can be flexible and varied, and a series of products can be derived. Only a few simple deductions or replacements should be considered as belonging to the scope of protection defined by the claims as filed.

What is claimed is:

1. A double-handle faucet body structure includes a first metal pipe, a second metal pipe, a first valve seat plugged into said first metal pipe, a second valve seat plugged into said second metal pipe, and a housing wrapped and connected to said first valve seat and said second valve seat, wherein:
said first valve seat has a first valve tube, a first inner tube provided under said first valve tube, and a first threaded tube provided on said first valve tube; said first inner tube is inserted into said first metal tube; a first side tube is provided at a side portion of said first valve tube;
said second valve seat has a second valve tube, a second inner tube provided under said second valve tube, and a second threaded tube provided on said second valve tube; said second inner tube is inserted into said second metal tube; a second side tube is provided at a side portion of said second valve tube.

2. The double-handle faucet body structure according to claim 1, wherein said first inner tube is fixedly connected with said first metal tube, and a top end of said first metal tube abuts against a bottom end of said first valve tube to be fixedly connected.

3. The double-handle faucet body structure according to claim 1, wherein said first inner tube is fixedly connected with said first metal tube, and a top end of said first metal tube abuts against a bottom ends of said first valve tube to be fixedly connected.

4. The double-handle faucet body structure according to claim 1, wherein said first side tube is in communication with said first valve tube, and said second side tube is in communication with said second valve tube.

5. The double-handle faucet body structure according to claim 1, wherein an upper portion and a lower portion of said first valve tube are respectively provided with an upper flange and a lower flange along an outer wall thereof.

6. The double-handle faucet body structure according to claim 1, wherein said housing includes a connecting tube, a first valve housing and a second valve housing arranged at both ends of said connecting tube; said first valve housing wraps said first valve tube, said second valve housing wraps said second valve tube.

7. The double-handle faucet body structure according to claim 6, wherein said first valve seat and said second valve seat are arranged side by side so that said first side tube and said second side tube are opposite to each other, and said first side tube and said second side tube are respectively accommodated in said connecting tube; a water outlet is provided in said middle of said connecting tube.

8. The double-handle faucet body structure according to claim 7, wherein a plurality of reinforcing ribs is provided at joints between said connecting tube and said first valve housing and said second valve housing.

9. A forming mold for said double-handle faucet body structure according to claim 1, comprising a mold base, a stationary mold core disposed on said mold base, and a movable mold core cooperating with said stationary mold core; wherein a first valve seat forming cavity, a second valve seat forming cavity and a housing forming cavity are provided on said stationary mold core; said first valve seat forming cavity includes an accommodating cavity that receives said first metal tube, a valve seat forming cavity provided at a top of said housing forming cavity, and a side tube forming cavity; said movable mold core is provided with a first mating cavity that cooperates with said first valve seat forming cavity and a second mating cavity that cooperates with said second valve seat forming cavity.

10. The forming mold according to claim 9, wherein said housing forming cavity includes a connecting tube forming cavity, a first valve seat forming cavity and a second valve seat forming cavity arranged both ends of said connecting tube forming cavity; said movable mold core is provided with a third fitting cavity matching with said housing forming cavity.
